(19) United States
(12) Patent Application Publication
(10) Pub. No.: US 2024/0015182 A1
(43) Pub. Date: Jan. 11, 2024

(54) DEVICE FOR PROVIDING PROTECTIVE SERVICE AGAINST EMAIL SECURITY-BASED ZERO-DAY URL ATTACK AND METHOD FOR OPERATING SAME

(71) Applicant: KIWONTECH CO., LTD., Seoul (KR)

(72) Inventor: Chung Han KIM, Seoul (KR)

(21) Appl. No.: 18/255,324

(22) PCT Filed: Dec. 29, 2020
(86) PCT No.: PCT/KR2020/019256

§ 371 Date: May 31, 2023

(51) Int. Cl. H04L 9/40

(52) U.S. Cl. CPC H04L 63/1483; H04L 63/1416

(57) ABSTRACT

A method for operating a device for providing a protective service against a mail security-based zero-day uniform resource locator (URL) attack, according to an embodiment of the present invention, comprises: a collection step of collecting email information transmitted and received between one or more user terminals; a security threat inspection step of, when a URL is included in the email information, inspecting the URL by means of a email security process according to a preset security threat architecture and storing and managing URL inspection information according to the inspection result; a zero-day URL conversion step of, when the URL is determined as a zero-day URL having a potential zero-day attack risk, converting the zero-day URL into a preset secure URL on the basis of the URL inspection information; and a zero-day URL diagnosis step of periodically diagnosing whether the zero-day URL is a malicious URL.

### TECHNICAL FIELD

The present invention relates to a device for providing a protective service against a mail security-based zero-day URL attack, and a method for operating the same, and more particularly, to a device for providing a protective service against a mail security-based zero-day URL attack, and a method for operating the same, which can detect and block zero-day attacks that pose security threats through URLs included in a mail.

### BACKGROUND ART

In today's society, dependency on cyberculture is increasing in all areas of social life around the world due to advancement in computers and information and communication technologies, and this trend is further accelerated. Recently, as 5G mobile communication with ultra-high speed, ultra-low delay, and hyper-connectivity is commercialized and new services based thereon are introduced, cyber security is becoming more important.

Technical fields such as Internet of Things (IoT), cloud systems, big data, artificial intelligence (AI), and the like provide a new service environment in combination with the information and communication technologies. A system that provides such a service may be connected to a PC, a portable terminal device, or the like through an Internet network, a wireless network, or the like to be used in real life.

As the information and communication technologies connected to various terminal devices or communication devices are getting more closely related to real life in this way, cyber security threats with malicious intention using the technologies are increasing day by day. As sophisticated and advanced cyber security threats induce abnormal execution of information and communication terminal devices of organizations, institutions, or individuals or induce human errors through forgery and alteration of management information, damage such as stealing and destroying information may be generated. In addition, information illegally stolen through the cyber security threats may also be used to commit monetary fraud crimes or other economic and social crimes.

An information protection system that protects and manages systemized information and communication technologies may be used to block and respond to the cyber security threats. The information protection system may be constructed according to the system type or technical features of the information and communication technologies and applied in steps to respond to various cyber threats.

Email systems used in the information and communication technologies may provide electronic mail service including a message body to send and receive messages using communication lines between users through computer terminals. At this point, emails may attach electronic files containing contents to be shared, and a link (URL; uniform resource locator) for connecting to a website may be written in the message body or inserted in the attached file.

In this way, an executable electronic file containing malicious codes may be attached or a URL that allows connection to a specific website may be inserted through the email system with a malicious intention. Through this, as the email recipients are persuaded to execute the malicious codes or access a forged or altered website through the inserted URL, processing of information not intended by the user may be performed, and information can be stolen.

In order to respond to the email security threats that may induce economic and social damage and lead to various crimes, a ‘system for controlling and blocking electronic mail attached with malicious codes’ is disclosed in Korean Patent Registration No. 10-1595379. The registered patent describes a system for controlling and blocking electronic mail attached with malicious codes, and the system includes: a target system having a function of receiving electronic mail sent from an external server or a terminal and received via a firewall and a spam blocking device embedded with spam blocking software, a function of confirming whether the electronic mail has an attached file, transmitting the electronic mail to a mail server when there is no attached file, and preventing infection of a malicious code by blocking the electronic mail except for the types of attached files (document, compression, image) most frequently used for user's business purposes when there is an attached file, a function of transmitting the electronic mail to the mail server when the type of the attached file is an image since it cannot be infected with a malicious code as an image cannot be converted, and transmitting a notification mail to the user terminal, when the type of the attached file is a document, by selecting one or more among the electronic mail, messenger, mobile communication, and KakaoTalk in a way of converting the document into an unmodifiable PDF form to prevent the user terminal from being infected by a malicious code when the mail recipient clicks a URL reflected with a malicious code in the document, a function of decompressing the attached file and analyzing a file type when the type of the attached file is a compressed file, processing in the method described above when the type of the attached file is an image, converting the attached file into a PDF file and processing in the method described above when the type of the attached file is a document, performing inspection and treatment of malicious code infection in a Virtual BOX equipped with various types of malicious code treatment solutions, and sending a notification mail including a result thereof to the mail server by selecting one or more among electronic mail, messenger, mobile communication, and KakaoTalk when the type of the attached file is an execution file, and a function of sending an attached file that requires malicious code inspection, other than the execution file, to the Virtual BOX to inspect and treat the malicious code, and receiving a result thereof; a virtual box for receiving an execution file from the target system, which configures a virtualized environment as a separate system and mounts various types of malicious code treatment solutions to inspect and treat malicious codes hidden in the execution file, transfer a result thereof to the target system, and process restoration to an environment before the inspection; a mail server having a function of receiving electronic mail (including notification mail) from the target system and forwarding the electronic mail (including notification mail) to the user terminal; and the user terminal having a function of selecting, when a notification mail is received from the target system, permission or rejection of the original electronic mail through confirmation of the notification mail, and a function of confirming the received electronic mail after logging in, by the user.

The system for controlling and blocking electronic mails attached with malicious codes may configure a virtualized environment to perform inspection and treatment on a mail containing attached files capable of executing hacking codes (or malicious codes). However, this is limited to inspection of malicious codes that can be included in attached files. In addition, a method of converting an attached file into a PDF format, when a malicious code is suspected to be contained in the attached file, and forwarding a PDF file to the recipient has limitations in preventing security risks when the recipient directly clicks a URL included in the PDF file or inputs a URL into a web browser. In addition, there is a limit in responding to malicious URLs that may be included in the message body of the mail, other than the attached file.

### DISCLOSURE OF INVENTION

### Technical Problem

Therefore, the present invention has been made in view of the above problems, and it is an object of the present invention to provide a device for providing a protective service against a mail security-based zero-day URL attack, and a method for operating the same, which can extract and inspect URLs that can be included in a message body, an attached file, or the like of incoming mail processed by an email system, and particularly provide a security zone, in the case of a zero-day URL without having reputation information, to a user until data that can be guaranteed as a normal URL is accumulated so that emails may go through the security zone first when URL connection is requested, and the connection is allowed when safety is guaranteed through security inspection performed on the URL.

### Technical Solution

To accomplish the above object, according to one aspect of the present invention, there is provided a method of operating a service providing device, the method comprising: a collection step of collecting information on mail transmitted and received between one or more user terminals; a security threat inspection step of inspecting, when a URL is included in the email information, the URL by a mail security process according to a preset security threat architecture, and storing and managing URL inspection information according to a result of the inspection; a zero-day URL conversion step of converting, when the URL is determined as a zero-day URL having a potential zero-day attack risk, the zero-day URL into a preset secure URL on the basis of the URL inspection information; and a zero-day URL diagnosis step of periodically diagnosing whether the zero-day URL is a malicious URL.

According to another aspect of the present invention, there is provided a service providing device comprising: a collection unit for collecting information on mail transmitted and received between one or more user terminals; a security threat inspection unit for inspecting, when a URL is included in the email information, the URL by a mail security process according to a preset security threat architecture, and storing and managing URL inspection information according to a result of the inspection; a zero-day URL conversion unit for converting, when the URL is determined as a zero-day URL having a potential zero-day attack risk, the zero-day URL into a preset secure URL on the basis of the URL inspection information; and a zero-day URL diagnosis unit for periodically diagnosing whether the zero-day URL is a malicious URL.

Meanwhile, the method according to an embodiment of the present invention for solving the problems may be implemented as a program for executing the method or a computer-readable recording medium in which the program is recorded.

### Advantageous Effects

According to an embodiment of the present invention, information free of security threats may be provided to a recipient (user) by performing a security inspection on the URL that can be included in the message body or an attached file of an incoming mail. Particularly, when a zero-day URL analyzed as a normal URL or not a malicious URL is detected, the zero-day URL is converted into a secure URL, and a primary connection can be processed using the URL that secures security when a recipient (user) requests connection to the URL. At the same time, security inspection is performed on the zero-day URL that is actually written, and the recipient (user) is allowed to connect only when the URL is determined to be safe. In addition, the malicious purpose of distributing malicious URLs through multiple linking steps can be blocked by tracing and inspecting additional URLs linked from and derived from the zero-day URL. In this way, the malicious purpose of generating zero-day malicious URLs using insufficient evaluation information on new URLs and aiming at stealing user information, attacking systems, disseminating malicious codes, and the like can be blocked in advance, and damage of users can be prevented. Through this, email service that guarantees safe exchange and processing of information between users can be provided.

### BRIEF DESCRIPTION OF THE DRAWINGS

FIG. 1 is a conceptual view showing an entire system according to an embodiment of the present invention.

FIG. 2 is a block diagram for explaining a device for providing a protective service against a mail security-based zero-day attack according to an embodiment of the present invention.

FIG. 3 is a flowchart for explaining a method of operating a device for providing a protective service against a mail security-based zero-day attack according to an embodiment of the present invention.

FIG. 4 is an exemplary view for explaining an incoming mail applied with URL conversion through a device for providing a protective service against a mail security-based zero-day attack according to an embodiment of the present invention.

FIGS. 5A and 5B are exemplary views for explaining comparison of URL access paths according to incoming routes of mail through a device for providing a protective service against a mail security-based zero-day attack according to an embodiment of the present invention.

FIG. 6 is an exemplary view for explaining an inspection method according to an architecture of a mail security service according to an embodiment of the present invention.

FIGS. 7A, 7B, and 7C are exemplary views for explaining an inspection method according to a mail security architecture according to an embodiment of the present invention.

### BEST MODE FOR CARRYING OUT THE INVENTION

Hereinafter, only the principles of the present invention will be exemplified. Therefore, although not clearly described or shown in this specification, those skilled in the art will be able to implement the principles of the present invention and invent various devices included in the spirit and scope of the present invention. In addition, it should be understood that all conditional terms and embodiments listed in this specification are, in principle, clearly intended only for the purpose of understanding the concept of present invention, and not limited to the embodiments and states specially listed as such.

In addition, it should be understood that all detailed descriptions listing specific embodiments, as well as the principles, aspects, and embodiments of the present invention, are intended to include structural and functional equivalents of such matters. In addition, it should be understood that such equivalents include equivalents that will be developed in the future, as well as currently known equivalents, i.e., all devices invented to perform the same function regardless of the structure.

Accordingly, for example, the block diagrams in the specification should be understood as expressing the conceptual viewpoints of illustrative circuits that embody the principles of the present invention. Similarly, all flowcharts, state transition diagrams, pseudo code, and the like may be practically embodied on computer-readable media, and it should be understood that regardless of whether or not a computer or processor is explicitly shown, they show various processes performed by the computer or processor.

In addition, explicit use of the terms presented as processors, controls, or concepts similar thereto should not be interpreted by exclusively quoting hardware having an ability of executing software, and should be understood to implicitly include, without limitation, digital signal processor (DSP) hardware, and ROM, RAM and non-volatile memory for storing software. Other known common hardware may also be included.

The above objects, features and advantages will become more apparent through the following detailed description related to the accompanying drawings, and accordingly, those skilled in the art may easily implement the technical spirit of the present invention. In addition, when it is determined in describing the present invention that the detailed description of a known technique related to the present invention may unnecessarily obscure the gist of the present invention, the detailed description thereof will be omitted.

The terms used in this specification are used only to describe specific embodiments, and are not intended to limit the present invention. Singular expressions include plural expressions unless the context clearly dictates otherwise. It should be understood that in this specification, terms such as “comprise” or “have” are intended to specify existence of a feature, a number, a step, an operation, a component, a part, or a combination thereof described in the specification, not to preclude the possibility of existence or addition of one or more other features, numbers, steps, operations, components, parts, or combinations thereof.

Hereinafter, preferred embodiments of the present invention will be described in more detail with reference to the accompanying drawings. In describing the present invention, in order to facilitate the overall understanding, the same reference numerals are used for the same components in the drawings, and duplicate descriptions of the same components are omitted.

A ‘mail (email)’ used in this specification may collectively refer to terms such as electronic mail, web email, electronic mail, electronic mail materials, and the like exchanged between a user and a terminal device using a computer communication network through a client program installed in the terminal device or a website.

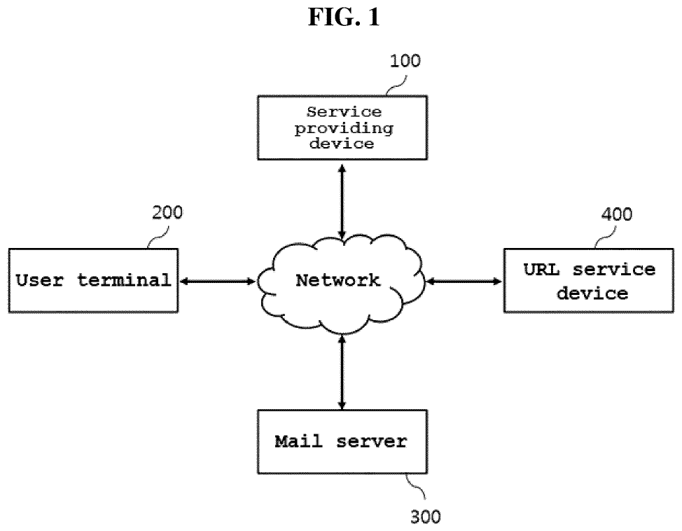

FIG. 1 is a conceptual view showing an entire system according to an embodiment of the present invention.

Referring to FIG. 1, a system according to an embodiment of the present invention includes a service providing device 100, a user terminal 200, a mail server 300, and a URL service device 400.

More specifically, the service providing device 100, the user terminal 200, the mail server 300, and the URL service device 400 are connected to a public network in a wired or wireless manner to transmit and receive data. The public network is a communication network constructed and managed by the country or a telecommunication infrastructure operator, and generally includes a telephone network, a data network, a CATV network, a mobile communication network, and the like, and provides connection services so that unspecified many people may access other communication networks or the Internet. In the present invention, the public network is described as a network.

In addition, the service providing device 100, the user terminal 200, the mail server 300, and the URL service device 400 may include a communication module for communicating using a protocol corresponding to each communication network.

The service providing device 100 may be connected to each user terminal 200 and the mail server 300 through a wired/wireless network to provide a mail security service, and devices or terminals connected to each network may communicate with each other through a preset network channel. In addition, when the user terminal 200 requests a connection to use a URL included in the message body or an attached file of an incoming mail, it may be connected to the URL service device 400 that is connected through the wired/wireless network and provides the service.

Here, each of the networks may be implemented as any one type of wired/wireless networks, such as a local area network (LAN), a wide area network (WAN), a value-added network (VAN), a personal area network (PAN), a mobile communication network, or a satellite communication network.

The service providing apparatus 100 described in this specification may provide a mail security service capable of detecting and blocking unintended execution of a program through a mail, unauthorized leakage of information, and attacks that lead to lowered data processing power, phishing scam, and the like of mail-related systems.

In addition, although the user terminal 200 described in this specification may include a personal computer (PC), a laptop computer, a mobile phone, a tablet PC, a Personal Digital Assistant (PDA), a Portable Multimedia Player (PMP), and the like, the present invention is not limited thereto, and the user terminal may be a device that can be connected to the service providing apparatus 100 and the mail server 300 through a public network or a private network.

In addition, each device may be a device of various types capable of inputting and outputting information by driving an application or browsing the web. Particularly, it is general that user terminals 200 may be connected to the service providing apparatus 100 through an individual security network.

The mail server 300 is a system that relays and stores electronic mail contents so that a user may send a mail written through the user terminal 200 or receive a mail written by a counterpart through the user terminal 200. The mail server 300 may communicate using a pre-set protocol according to the purpose of receiving and sending mails.

Generally, Post Office Protocol 3 (POP3) and Internet Message Access Protocol (IMAP) may be used as the protocol when a mail is received. In addition, Simple Email Transfer Protocol (SMTP) may be used as the protocol when sending a mail. In this way, the mail server 300 may be configured to operate as a server system for processing mail transmission and reception. In addition, the mail server 300 may be subdivided into a mail receiving server and a mail sending server to provide their functions.

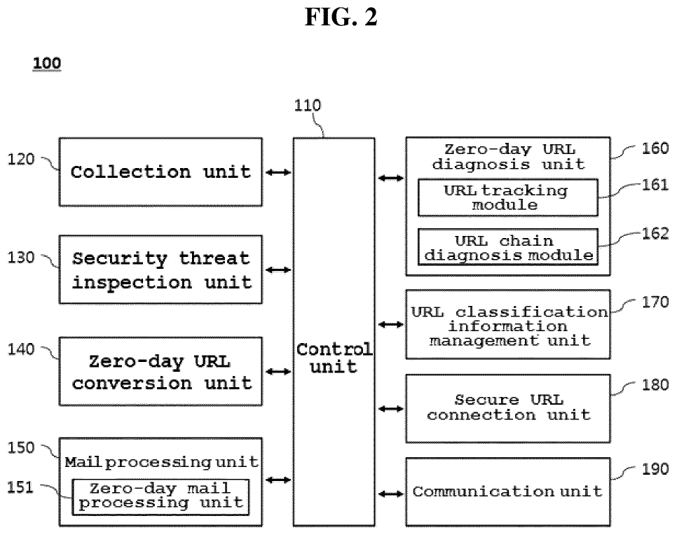

FIG. 2 is a block diagram for explaining a device for providing a protective service against a mail security-based zero-day attack according to an embodiment of the present invention.

Referring to FIG. 2, the service providing device 100 according to an embodiment of the present invention may include a control unit 110, a collection unit 120, a security threat inspection unit 130, a zero-day URL conversion unit 140, a mail processing unit 150, a zero-day URL diagnosis unit 160, a URL classification information management unit 170, a secure URL connection unit 180, and a communication unit 190. Additionally, the mail processing unit 150 may include a zero-day mail processing unit 151. In addition, the zero-day URL diagnosis unit 160 may include a URL tracking module 161 and a URL chain diagnosis module 162.

The control unit 110 may be implemented as one or more processors for overall control of the operation of each component in the service providing apparatus 100.

The collection unit 120 may collect mail information transmitted and received between one or more user terminals 200. The mail information may include email header information, an email subject, an email message body, the number of times of receiving mail during a predetermined period, and the like.

Specifically, the email header information may include the IP address of the mail sending server, information on the host name of the mail sending server, information on the mail domain of the sender, the mail address of the sender, the IP address of the mail receiving server, information on the host name of the mail receiving server, information on the mail domain of the recipient, the mail address of the recipient, information on the protocol of the mail, information on the time of receiving the mail, information on the time of sending the mail, and the like.

In addition, the email header may include network path information required in the process of sending and receiving mail, information on the protocol used between mail service systems for exchanging mail, and the like.

Additionally, the mail information may include an extension of an attached file, hash information of the attached file, a name of the attached file, a contents body of the attached file, uniform resource locator (URL) information, and the like. The attached file may include additional contents for transferring additional information or requesting reply of information, in addition to the message body of the mail that the sender desires to transfer to the recipient. The URL may be confirmed as information included in the message body of the mail or included in the contents of the attached file.

The contents may provide text, images, videos, and the like. The recipient may confirm the contents by executing an application corresponding to the file attached to the mail. In addition, the recipient may download the file attached to the mail to a local storage device to store and manage therein. At this point, the URL in the contents may be included as text information. Through this, when the user terminal 200 requests connection to the URL, the service provided by the URL service device 400 may be confirmed. The URL may be called by a script or the like executed in a web page. In addition, the URL may be called by an event generated by the user terminal 200 in a web page or the like.

The extension of an attached file may distinguish a file format or type. The extension of an attached file may be generally distinguished by a character string indicating file attributes or an application creating the file. For example, a text file may be distinguished by an extension such as [file name].txt, an MS-word file by [file name].doc (docx), and a Hangul file by [file name].hwp. In addition, the extension of an image file may be classified into gif, jpg, png, tif, and the like.

Additionally, an execution file, which is a computer file performing a task directed according to a coded command, may be classified into [filename].com, [filename].exe, [filename].bat, [filename].dll, [filename].sys, [filename].scr, and the like.

The hash information of the attached file may guarantee integrity of information by inspecting forgery and alteration of the information. The hash information or hash value may be mapped to a bit string of a predetermined length for arbitrary data having a predetermined length through a hash function.

Through this, hash information output through the hash function for the initially created attached file has a unique value. The output hash information or hash value has a unidirectionality that does not allow extraction of data inversely input into the function. In addition, the hash function may guarantee avoidance of collision that cannot be accomplished by calculation of another input data that provides an output the same as the hash information or hash value output for one given input data. Accordingly, when data of the attached file is changed or added, the hash function returns a different output value.

As the unique hash information of the attached file allows comparison of hash information or hash value for a file exchanged through a mail in this way, modification, forgery, alteration of the file can be confirmed. In addition, since the hash information is fixed as a unique value, preventive measures can be taken in advance by utilizing reputation information, which is a database of history for the files created with a malicious intention. Additionally, the hash function may be used in a technique and version that can guarantee unidirectionality and collision avoidance.

For example, the hash information may be used as information for searching for existence of a malicious code in a file through a Virus Total website or a Malwares website. In addition, the website may provide information on evaluation of abnormality and analysis of URL information. Information such as a file provider, a hash value of a file, and the like may be provided through a website that provides analysis of hash information of the file. In addition, as a result of searching for the hash information of a file may be used to cross-check the reputation information determined by global companies that provide a number of IT information security solutions, it is possible to determine with more reliable information.

According to a preset security threat architecture, when a Uniform Resource Locator (URL) is included in the mail information, the security threat inspection unit 130 may inspect the URL by a mail security process, and store and manage URL inspection information according to the inspection result. The security threat architecture may be classified into a spam mail security threat, a malicious code security threat, a social engineering security threat, and an internal information leakage security threat. The type, level, process, priority, and processing order of the security threats may be set by the security threat architecture.

The email security process corresponding to the security threat architecture may include a spam mail security process, a malicious code security process, a phishing mail security process, and a mail export security process. Particularly, inspection on whether or not a URL is included in the mail information may be included in the malicious code security process among the mail security processes.

The security threat inspection unit 130 may perform inspection on URLs detected in the mail information through the malicious code security process among the mail security processes. The security threat inspection unit 130 may detect URL information that may be included in the message body of a mail and the attached files through a text-based extraction method, an image-based extraction method, or the like. In addition, in the case of attached files configured in a web form, whether a URL is detected may be inspected on the source code. Through this, the security threat inspection unit 130 may obtain inspection results by mapping the extracted URL to a blacklist or whitelist managed by itself. Alternatively, the security threat inspection unit 130 may match the extracted URL in association with reputation analysis URL information analyzed and shared by domestic and foreign organizations, companies, portal companies, and the like related to cyber security.

For example, when a URL detected by the security threat inspection unit 130 is confirmed as ‘www.*fake-url*.com’, the detected URL may be primarily matched to reputation analysis URL information. Through this, the security threat inspection unit 130 may perform cross-check on the information obtained by evaluating the URL, and obtain inspection information about whether the URL is a trusted (normal) URL or a malicious URL.

In addition, according to a preset security threat architecture, the security threat inspection unit 130 may process step-by-step matching of a mail security process corresponding to the mail information, inspect the mail information by the matching-processed mail security process, and store and manage mail security inspection information according to a result of the inspection.

As for the mail security process, a different mail security process corresponding to an incoming mail or an outgoing mail may be determined according to the security threat architecture. In addition, the inspection order or inspection level of the mail security process may be determined by a preset security level and architecture.

In the mail security process, a flexible resource allocation method of allocating an independently classified process as a resource when mail information for receiving or sending mail is transmitted from the user terminal 200, and immediate execution of the process in an inspection area allocated from the mail information may be explained as the concept of a virtual space. In the method of allocating resources in a virtual space, when the process is completed, the mail security process may immediately process the work in the inspection area allocated from mail information that flows in sequentially.

Contrarily, when a requested task is processed, a virtual environment, i.e., an environment in which a predetermined process of which the processing is limited within a single resource is assigned like a virtual machine, may have an idle time in which other processes wait until a specific process is completed. In a method of analyzing through a process like this, flexible resources may have an advantage in processing speed and performance in comparison with fixed resources.

The security threat inspection unit 130 may classify mails by reception or transmission purposes according to the mail information collected by the collection unit 120. Thereafter, the security threat inspection unit 130 may acquire mail security inspection information for each mail by matching and analyzing the mail security process sequentially or based on a set priority.

The spam mail security threat may include mail types unilaterally and indiscriminately distributed to unspecified many people in large quantities for the purpose of advertisement, public relations, and the like between unrelated senders and receivers. In addition, a large quantity of spam mails may impose load on the data processing power of the mail system and lower the processing capability of the system. In addition, the spam mail has a risk in that users may be unintentionally linked to indiscriminate information included in the message body or the like, and it may be disguised as information for potential phishing scam.

The security threat inspection unit 130 may include a spam mail inspection unit (not shown) to detect and filter spam mails like this. The spam mail inspection unit may match, when the mail security process is a spam mail security process, the mail information including mail header information, mail subject, mail message body, the number of times of receiving mail during a predetermined period, and the like to preset spam indexes step by step.

The spam mail inspection unit may use mail information including mail header information, mail subject, mail message body, and the like as inspection items in the spam indexes through a predetermined pattern inspection or the like that may classy a mail as a spam mail. Through this, the spam mail inspection unit may acquire, store, and manage spam mail inspection information by matching the spam indexes step by step.

Inspection items based on the items included in the mail information and level values obtained through inspection may be set in steps as the spam indexes. According to an embodiment of the present invention, the spam indexes may be subdivided and configured in steps of Level 1, Level 2, Level 3, . . . , Level [n].

Spam index level 1 may match mail subject data included in the mail information on the basis of big data and reputation information. Through this, an evaluated level value may be acquired as inspection information of spam index level 1. The level value may be set as information that can be quantitatively measured. For example, when the mail subject, which is an inspection item, includes a phrase such as ‘advertisement’, ‘public relations’, or the like, and matches the information defined as a spam mail in the big data and reputation information, the inspection information of spam index level 1 may be evaluated as ‘1’ among the level values classified into 0 and 1. Through this, inspection information of spam index level 1 may be acquired as ‘1’.

Additionally, spam index level 2 may match data included in the mail information on the basis of user-designated keywords. Through this, an evaluated level value may be acquired as inspection information of spam index level 2. For example, when the mail message body, which is an inspection item, includes a keyword including ‘Special price’, ‘Super special price’, ‘Bargain’, ‘Sale’, ‘Sold out’, or the like, and matches the information defined as a spam mail in the user-designated keywords, the inspection information of spam index level 2 may be evaluated as ‘1’ among the level values classified into 0 and 1. Through this, inspection information of spam index level 2 may be acquired as ‘1’.

As the next step, spam index level 3 may match data included in the mail information on the basis of image analysis. Through this, an evaluated level value may be acquired as inspection information of spam index level 3. For example, when data extracted by analyzing an image included in the mail message body, which is an inspection item, includes a phone number starting with ‘080’, and matches the information defined as a spam mail in the image analysis, the inspection information of spam index level 3 may be evaluated as ‘1’ among the level values classified into 0 and 1. Through this, inspection information of spam index level 3 may be acquired as ‘1’.

In this way, the inspection information acquired in units of spam index levels through the spam mail security process may be finally summed up as ‘3’ and stored and managed as spam mail inspection information. The spam mail inspection information summed up in this way may be included and managed in the mail security inspection information, and may be used as security threat determination information in the mail processing unit 150.

The security threat inspection unit 130 may further include a malicious code inspection unit (not shown). When the mail security process is a malicious code security process, the malicious code inspection unit may match the mail information, further including the extension of the attached file, hash information of the attached file, the name of the attached file, the contents body of the attached file, uniform resource locator (URL) information, and the like, to a preset malicious code index step by step.

The malicious code inspection unit may use the contents body of the attached file and the uniform resource locator (URL) information included in the message body, together with the extension of the attached file, hash information of the attached file, the name of the attached file, and the like, which can be confirmed from the attribute values of the attached file, as malicious code index inspection items. Through this, the malicious code inspection unit may acquire, store, and manage malicious code inspection information by matching the malicious code indexes step by step according to the items.

Inspection items based on the items included in the mail information and level values obtained through inspection may be set as the malicious code indexes step by step. According to an embodiment of the present invention, the malicious code indexes may be subdivided and configured in steps of Level 1, Level 2, Level 3, . . . , Level [n].

Malicious code index level 1 may match the name of the attached file or the extension of the attached file included in the mail information on the basis of big data and reputation information. Through this, an evaluated level value may be acquired as inspection information of malicious code index level 1. For example, when the name of the attached file or the extension of the attached file, which are inspection items, includes ‘Trojan’ or ‘exe’, and matches the information defined as a malicious code in the big data and reputation information, the inspection information of malicious code index level 1 may be evaluated as ‘1’ among the level values classified into 0 and 1. Through this, inspection information of malicious code index level 1 may be acquired as ‘1’.

Additionally, malicious code index level 2 may match hash information of the attached file of a mail on the basis of big data and reputation information. Through this, an evaluated level value may be acquired as inspection information of malicious code index level 2. For example, when the hash information of the attached file, which is an inspection item, is analyzed as ‘a1b2c3d4’, and matches the information defined as a malicious code in the reputation information, the inspection information of malicious code index level 2 may be evaluated as ‘1’ among the level values classified into 0 and 1. Through this, inspection information of malicious code index level 2 may be acquired as ‘1’.

As the next step, malicious code index level 3 may match uniform resource locator (URL) information included in the attached file or the mail message body on the basis of URL reputation information. Through this, an evaluated level value may be acquired as inspection information of malicious code index level 3. For example, when the URL information, which is an inspection item, is confirmed as ‘www.malicious-code.com’, and matches the information defined in the URL reputation information as a harmful site including a malicious code file, the inspection information of malicious code index level 3 may be evaluated as ‘1’ among the level values classified into 0 and 1. Through this, inspection information of malicious code index level 3 may be acquired as ‘1’. In addition, the malicious code inspection unit may respond to zero-day attacks that may be omitted in the URL reputation information. The malicious code inspection unit may change a link IP address for a URL without having reputation information to an IP address of a specific system and provide the changed IP address to the user terminal 200. When the user terminal 200 desires to access the URL, it may access the IP address of the specific system changed by the malicious code inspection unit. The specific system that has been previously changed to a link IP address for the URL may continuously inspect whether or not a malicious code is included up to the endpoint of the URL.

In this way, the inspection information acquired in units of malicious code index levels through the malicious code security process may be finally summed up as ‘3’ and stored and managed as malicious code inspection information. The malicious code inspection information summed up in this way may be included and managed in the mail security inspection information, and may be used as security threat determination information in the mail processing unit 150.

The security threat inspection unit 130 may further include a phishing mail inspection unit (not shown). The phishing mail inspection unit may match, when the mail security process is a phishing mail security process, to relationship analysis information set in advance step by step. The relationship analysis information may be acquired through analysis of the mail information including mail information and attribute information of a mail confirmed as normal.

The phishing mail inspection unit may use the incoming mail domain, outgoing mail domain, incoming mail address, outgoing mail address, mail routing information, mail message body information, and the like, which can be extracted from a mail determined as normal, as relationship analysis index inspection items. Through this, the phishing mail inspection unit may acquire, store, and manage phishing mail inspection information by matching the relationship analysis indexes step by step according to the items. Through this, the phishing mail inspection unit may detect similar domains and filter mails that may pose a security threat by tracing or verifying mail delivery routes.

Inspection items based on the relationship analysis information and level values obtained through inspection may be set as the relationship analysis indexes step by step. According to an embodiment of the present invention, the relationship analysis indexes may be subdivided and configured in steps of Level 1, Level 2, Level 3, . . . , Level [n].

Relationship analysis index level 1 may match the domain of the sender's mail, the address of the sender's mail, and the like on the basis of reputation information. Through this, an evaluated level value may be acquired as inspection information of relationship analysis index level 1. For example, when the domain of an outgoing mail is ‘@phishing.com’ and the sender's mail address includes ‘phishing@’, which are inspection items, and matches the information defined as a malicious code in the reputation information, the inspection information of relationship analysis index level 1 may be evaluated as ‘1’ among the level values classified into 0 and 1.

Additionally, relationship analysis index level 2 may match the domain of the sender's mail, the address of the sender's mail, and the like on the basis of the relationship analysis information. Through this, an evaluated level value may be acquired as inspection information of relationship analysis index level 2. For example, when the domain of an outgoing mail is ‘@phishing.com’ and the sender's mail address includes ‘phishing@’, which are inspection items, and does not match the information defined as attribute information of a normal mail in the relationship analysis information, the inspection information of relationship analysis index level 2 may be evaluated as ‘1’ among the level values classified into 0 and 1. Through this, inspection information of relationship analysis index level 3 may be acquired as ‘1’.

As the next step, relationship analysis index level 3 may match mail routing information or the like on the basis of the relationship analysis information. Through this, an evaluated level value may be acquired as inspection information of relationship analysis index level 3. For example, when the mail routing information, which is an inspection item, is confirmed as ‘1.1.1.1’, ‘2.2.2.2’, and ‘3.3.3.3’, and the routing information, which is the mail transmission path, does not match the information defined as attribute information of a normal mail in the relationship analysis information, the inspection information of relationship analysis index level 3 may be evaluated as ‘1’ among the level values classified into 0 and 1. Through this, inspection information of relationship analysis index level 3 may be acquired as ‘1’.

In this way, the inspection information acquired in units of relationship analysis index levels through the phishing mail security process may be finally summed up as ‘3’ and stored and managed as phishing mail inspection information. The phishing mail inspection information summed up in this way may be included and managed in the mail security inspection information, and may be used as security threat determination information in the mail processing unit 150.

The security threat inspection unit 130 may include a mail export inspection unit (not shown) to respond to internal information leakage security threats. The mail export inspection unit 134 may match, when the mail security process is a mail export security process, mail information to a preset mail export management index on the basis of the mail information step by step.

The mail export inspection unit may use the attribute information of the mail information as a mail export management index inspection item. In addition, the management index inspection item may use internally managed information on the IP address assigned to the user terminal 200.

Inspection items set in advance and level values obtained through inspection may be step by step as the mail export management indexes. According to an embodiment of the present invention, the mail export management indexes may be subdivided and configured in steps of Level 1, Level 2, Level 3, . . . , Level [n].

The mail export management index may include an item for controlling to register only allowed IP addresses among the IP addresses assigned to the user terminal 200 as mail information for the inspecting the outgoing environment. Since an unauthenticated user terminal is likely to leak internal information and likely to pose a security threat through a mail, management indexes for preventing the leakage and threat may be managed.

In addition, the mail export inspection unit may classify the mail export management indexes into inspection items such as information on the IP address, information on the number of times of transmission, and the like. In addition, the mail export inspection unit 134 may reduce the threat of internal information leakage by additionally including a control unit, such as an approval process or the like, as an item for inspecting the outgoing environment of mail. Through this, the mail export inspection unit 134 may store and manage level values, calculated by matching the inspection item through the mail export process, as mail export inspection information.

The zero-day URL conversion unit 140 may convert a zero-day URL into a preset secure URL when a URL is determined as a zero-day URL having a potential risk of zero-day attack on the basis of the URL inspection information obtained through the security threat inspection unit 130. The zero-day attack can be made by maliciously making use of vulnerability in security, a situation in which a security attack defense system is not constructed, or the like before the existence of a problem related to an information and communication technology (ICT) system is announced or analyzed. At this point, a URL that is not determined or analyzed as a normal URL or a malicious URL through the reputation analysis URL information may be classified as a zero-day URL. The zero-day URL may have the possibility of zero-day attack according to the intention of the creator. The zero-day URL may be disguised as a normal URL, or malicious URLs may be included and derived from a URL that is linked and connected to a URL determined as a normal URL. In this way, the zero-day URL may be maliciously used as a means for zero-day attack.

Although the security threat inspection unit 130 determines whether the extracted URL is a trusted (normal) URL or a malicious URL by analyzing the evaluation information of the URL, there is a limit in obtaining evaluation information for a newly created URL. In addition, the security threat inspection unit 130 may not provide determination information about abnormality when the IP address mapped to the URL is not included in the blacklist or whitelist information. In this way, the zero-day URL conversion unit 140 may determine the extracted URL as a zero-day URL when the extracted URL does not correspond to the reputation analysis through internal and external management data and turns out to be unknown information.

Accordingly, the zero-day URL conversion unit 140 may convert a URL determined as a zero-day URL into a secure URL, which is reliable URL information, and include it in the mail information. The zero-day URL conversion unit 140 deletes the URL determined as a zero-day URL from the mail information and inserts a secure URL in the deleted part to convert the URL, and may create a URL conversion table to store and manage conversion history of deleted URLs and secure URLs. When a request for connection to a secure URL applied to an incoming mail that the user terminal 200 may view is generated from the user terminal 200, the URL conversion table may be used as information for connection to a verified zero-day URL.

The mail processing unit 150 may process the mail state according to analysis of the URL inspection information. The mail processing unit 150 may include a zero-day mail processing unit 151 for replacing the zero-day URL with a secure URL, and processing the mail including the zero-day URL to put into a receiving state that allows the user terminal to access.

The zero-day mail processing unit 151 may process the mail replaced with the secure URL to put into a receiving state, and the user terminal 200 may recognize the URL written in the message body or an attached file of the mail as a secure URL, not a zero-day URL written initially.

In addition, the mail processing unit 150 may process a mail state according to security threat determination information acquired through analysis of the mail security inspection information and the mail information.

The relationship analysis unit (not shown) may store and manage relationship analysis information acquired through analysis of the mail information and the trust authentication log. When the mail information is processed the mail processing unit 150 as a normal mail according to the security threat determination information, the trust authentication log may include record information including the incoming mail domain, outgoing mail domain, incoming mail address, outgoing mail address, mail routing information, mail message body information, and the like.

The mail processing unit 150 may perform the mail security process according to a preset priority. When the security threat determination information acquired through the mail security process is determined as an abnormal mail, the mail processing unit 150 may process the mail state by determining whether or not to stop subsequent mail security processes. Through this, when a problem is found first at the inspection step, the mail processing unit 150 may perform only the processes needed at the inspection step according to the priority, determine whether or not to stop the inspection, and terminate the process without performing subsequent inspection steps. Through this, complexity of the system can be reduced and processing efficiency can be improved by securing efficiency of the mail security service.

Information acquired by combining spam mail inspection information, malicious code inspection information, phishing mail inspection information, and mail export inspection information calculated by the security threat inspection unit 130 may be used as the mail security inspection information. For example, when the score calculated from the spam mail inspection information is ‘3’, the score calculated from the malicious code inspection information is ‘2’, the score calculated from the phishing mail inspection information ‘1’, and the score calculated from the mail export inspection information is ‘0’, the score summed up as the mail security inspection information through the process performed on the mail information by the security threat inspection unit 130 may be acquired as ‘7’. At this point, mails may be classified as abnormal mail when the overall score is in a range of 0 to 3 on the basis of the preset security threat determination information, as gray mail when the overall score is in a range of 4 to 6, and as abnormal mail when the overall score is in a range of 7 to 12. Accordingly, a mail of which the mail security inspection information is ‘7’ may be determined as an abnormal mail. In addition, a result value of each inspection information item included in the mail information inspection information may be assigned with an absolute priority according to the item, or the priority may be determined by the information according to a weight.

The mail processing unit 150 may include a mail distribution processing unit (not shown) for processing a mail determined as a normal mail according to the security threat determination information to put the mail into a receiving or sending state that can be processed by the user terminal.

In addition, the mail processing unit 150 may further include a mail discard processing unit (not shown) for processing a mail determined as an abnormal mail according to the security threat determination information to put the mail into a state that does not allow access of the user terminal.

In addition, the mail processing unit 150 may further include a mail harmless processing unit (not shown) for converting a mail determined as a gray mail according to the security threat determination information into non-execution file contents, and providing the non-execution file contents so that the user terminal may selectively process the mail state.

Generally, a gray mail may be classified into a spam mail or a junk mail, or may be classified as a normal mail on the contrary. In the present invention, the gray mail may be defined as a mail type that is classified when the security threat determination information is calculated as a medium value in a predetermined range, which cannot be determined as normal or abnormal. The mail harmless processing unit may convert the gray mail including the message body of suspicious contents into an image file and provides the mail in a state that the user terminal 200 may confirm. In addition, the mail harmless processing unit may remove or modify a part in an attached file being suspicious of a malicious code and provide the mail to the user terminal 200.

The zero-day URL diagnosis unit 160 may periodically diagnose whether the zero-day URL is a malicious URL. The malicious URL may include security threats such as inducing input of personal information, download of malicious codes, execution of malicious scripts, attack on web vulnerability, and the like.

Since the zero-day URL has not been used or evaluated previously, reliability of the services or contents provided from the connection established through the zero-day URL is not guaranteed. In addition, the zero-day URL may be provided for malicious purposes through forgery or alteration by imitating a normal web page. Of course, a zero-day URL that provides a normal service or contents may be generated. This is classified as a zero-day URL since it is the first time that the URL is provided.

However, since there is no information on the analysis and evaluation about what purpose the zero-day URL is served and the contents are provided, the possibility of executing an abnormal behavior by the user and being damaged cannot be ruled out. Accordingly, the zero-day URL should go through, as soon as it is discovered, a security inspection to be determined as a malicious URL or not.

The security inspection may include a primary step of extracting an IP address corresponding to the zero-day URL and re-matching the IP address to the blacklist. The blacklist may use database information in which IP addresses classified as harmful are stored. In addition, harmful IP address reputation analysis information, which is analyzed and shared by domestic and foreign organizations, companies, portal companies, and the like related to cyber security, may be utilized.

The blacklist matching inspection may be initially utilized for an inspection corresponding to reputation analysis URL information through the security threat inspection unit 130. However, the reputation analysis URL information and reputation information on harmful IP addresses may be additionally evaluated by the zero-day URL diagnosis unit 160 in order to utilize the analysis information updated in real time.

The zero-day URL diagnosing unit 160 may perform subsequent inspections according to the inspection result to determine whether an IP address mapped to the zero-day URL is a harmful IP address.

When the zero-day URL is determined as a zero-day URL that is not classified as normal or abnormal, the zero-day URL diagnosis unit 160 may access the zero-day URL and inspect whether the provided services or contents are normal.

The zero-day URL diagnosis unit 160 may access the zero-day URL and perform a behavior-based dynamic inspection. Through this, the zero-day URL diagnosis unit 160 may perform, step by step, inspection of whether the zero-day URL induces input of personal information, downloads malicious codes, induces download of malicious codes, or executes a malicious script. In addition, situations that may generate web vulnerability attacks can be inspected.

When a problem is found first at the inspection step, the zero-day URL diagnosis unit 160 may perform only the processes needed at the inspection step according to the priority, determine whether or not to stop the inspection, and terminate the process without performing subsequent inspection steps. Through this, complexity of the system can be reduced and processing efficiency can be improved by securing efficiency of the mail security service.

According to an embodiment of the present invention, the zero-day URL diagnosis unit 160 may perform inspection on whether a URL is malicious as follows.

First, the zero-day URL diagnosis unit 160 may re-inspect the reputation analysis URL information in real time.

For example, when ‘www.*zerodayurl1*.com’ determined as a zero-day URL is provided, the zero-day URL diagnosis unit 160 may primarily diagnose whether or not the ‘www.*zerodayurl1*.com’ is a malicious URL. At this point, whether or not a harmful IP address may also be diagnosed through the IP address information of ‘1.2.3.4’ obtained by analyzing an IP address mapped to ‘www.*zerodayurl1*.com’. The zero-day URL diagnosis unit 160 may confirm that the zero-day URL and the IP address mapped thereto still do not correspond to the reputation analysis information.

As a next step, the zero-day URL diagnosis unit 160 may directly connect to or access the zero-day URL and execute a behavior-based dynamic inspection.

For example, the zero-day URL diagnosis unit 160 may directly connect to or access ‘www.*zerodayurl1.com*’, which is a zero-day URL, and inspect whether or not the URL is forged or altered. The zero-day URL diagnosis unit 160 may configure a web page menu for providing financial services in the ‘www.*zerodayurl1*.com’, and confirm that it is a URL that induces input of personal information and financial information. The zero-day URL diagnosis unit 160 may inspect and determine whether it is a URL that intends to steal personal information or financial information. When it is determined as a malicious URL through the inspection, the zero-day URL diagnosis unit 160 detects that the ‘www.*zerodayurl1*.com’ is provided to be similar to the configuration of web page ‘www.*zerodayurl*.com’ that provides normal financial services, and evaluates the URL as a malicious URL when an attempt of stealing personal information and financial information of a user is confirmed. The ‘www.*zerodayurl1*.com’ determined as a malicious URL may induce users to misunderstand it as a normal URL and access the web page by adding number 1 to zerodayurl, i.e., a second-level domain of ‘www.*zerodayurl*.com’, which is a normal URL. In addition, the zero-day URL diagnosis unit 160 may inspect whether a file containing malicious codes is downloaded or the download is induced when the ‘www.*zerodayurl1*.com’ is connected or accessed. Additionally, the zero-day URL diagnosis unit 160 may inspect whether a malicious script is executed when the ‘www.*zerodayurl1*.com’ is connected or accessed. In addition to this, the zero-day URL diagnosis unit 160 mat grasp the execution operation of the menu provided by the ‘www.*zerodayurl1*.com’ and inspect whether there is an abnormality.

In addition, the zero-day URL diagnosis unit 160 may inspect whether an attack using web vulnerability or the like is made and determine whether it is normal. The web vulnerability may be maliciously used as a tool for achieving malicious purposes such as cyber-attacks, information theft, illegal acquisition of privileges, fraud, and the like through programming of the source code area. The web vulnerability may be configured of SQL injection, XPath injection, malicious contents injection, cross-site script (XSS), cross-site request modification, automated attack, file upload, cookie modification, and the like.

The zero-day URL diagnosis unit 160 may include a URL tracking module 161 for acquiring URL chain information by tracking and managing one or more first derived URLs connected from the zero-day URL and [n-th] derived URLs successively derived through the first derived URLs at regular intervals. The URL tracking module 161 may directly connect to or access the zero-day URL and inspect the provided services or contents to track URL information provided as an additional link. The URL tracking module 161 may acquire the URL chain information and use the URL chain information so that the URLs proved before as malicious URLs may be selected among the derived URLs linked and connected to the zero-day URL.

At this point, when the zero-day URL provides a service as a web page, the zero-day URL may form a menu on the web page. The zero-day URL may execute an additional operation of the web page through this, and may move to the first derived URL by providing an additional link. One or more first derived URLs may be provided in the web page provided by the zero-day URL. The web page connected to or accessed as the first derived URL is linked may provide a second derived URL, which is an additional link, through a menu or the like. One or more second derived URLs may be provided through one or more menus or the like. In this way, the zero-day URL may include a first derived URL through the provided services or contents, and the first derived URL may also include a second derived URL. In addition, the second derived URL may successively include third, fourth, and [n-th] derived URLs.

Through this, the URL tracking module 161 may acquire URL chain information for generating a map by combining the detected URL information, from the zero-day URL to the [n-th] derived URL.

Accordingly, the zero-day URL diagnosis unit 160 may inspect and determine whether or not a URL is malicious using the URL chain information including the zero-day URL, the first derived URL derived from the zero-day URL, and the second derived URL derived from the first derived URL. The zero-day URL diagnosis unit 160 may track and extract URL information from the zero-day URL up to the end point where the [n-th] derived URL is not detected at intervals of predetermined hours, minutes, or seconds, or according to a specific criterion that may be classified periodically.

In addition, the zero-day URL diagnosis unit 160 may further include a URL chain diagnosis module 162 for diagnosing whether the [n-th] derived URL is a malicious URL at regular intervals on the basis of the URL chain information, and storing and managing the chain diagnosis information.

The URL chain diagnosis module 162 may maintain the chain diagnosis information up-to-date by continuously updating the chain diagnosis information. Through this, the URL chain diagnosis module 162 may provide URLs determined as malicious URLs to be added to a blacklist in association with external organizations.

The URL classification information management unit 170 may store and manage information determined as one among a normal URL, a malicious URL, and a zero-day URL as URL classification information according to analysis of the URL inspection information. The URL classification information management unit 170 may include information for determining whether the zero-day URL and the [n-th] derived URL are abnormal in the URL classification information on the basis of the chain diagnosis information. Through this, the URL classification information management unit 170 may provide information capable of promptly responding to security threats by maintaining the URL classification information up-to-date.

When the user terminal 200 receiving a mail including the secure URL requests connection to the secure URL, the request is primarily provided to a security zone redirected from the user terminal 200. The secure URL connection unit 180 may process connection to the zero-day URL and the [n-th] derived URL determined not to be a malicious URL on the basis of the diagnosis information.

For example, the user terminal 200 may confirm an incoming mail in which ‘www.*zerodayurl123*.com’ (mapping IP address: 1.1.1.1), which is a zero-day URL initially written in the mail contents, is replaced with ‘www.*security123*.com’ (mapping IP address: 10.10.10.10), which is a secure URL. Alternatively, secure URL conversion information obtained by converting an IP address mapped thereto may be applied without changing ‘www.*zerodayurl123*.com’, which is a zero-day URL, when the user terminal 200 requests a connection. The user terminal 200 may attempt to connect by clicking or inputting the ‘www.*security123*.com’ in the web browser to additionally confirm the mail contents. At this point, when the user terminal 200 requests connection by clicking the ‘www.*security123*.com’ written in the mail contents, the user terminal 200 may be primarily redirected to access 10.10.10.10, which is the IP address of the secure URL connection unit 180. Thereafter, movement to IP address 1.1.1.1 mapped to ‘www.*zerodayurl123*.com’ may be allowed or rejected according to the malicious URL inspection information. Information thereon may be provided to a notification window or the like to be confirmed by the user terminal 200.

The record management unit (not shown) may store and manage the mail information processed according to the security threat determination information as record information. The record management unit may further include a relationship information management unit (not shown) for storing and managing, when a mail is processed as a normal mail according to the security threat determination information, the record information including the incoming mail domain, outgoing mail domain, incoming mail address, outgoing mail address, mail routing information, mail message body information, and the like as a trust authentication log. The record management unit may additionally include normal URL information in the trust authentication log on the basis of information on determining whether or not the URL included in the message body of the mail is abnormal. Through this, the trust authentication log may be used for reliable relationship information analysis on the recipient's and sender's mail information. In addition, reliability of the information included in the trust authentication log can be guaranteed as data are continuously accumulated through exchange of information therebetween.

In addition, when a mail is processed as an abnormal mail according to the security threat determination information, the record management unit may use the record information including the incoming mail domain, outgoing mail domain, incoming mail address, outgoing mail address, mail routing information, mail message body information, and the like as an index for determining an abnormal mail when the mail security process is performed. In addition, the record management unit may additionally include malicious URL information as an index for determining an abnormal mail on the basis of information for determining whether a URL included in the message body of the mail is abnormal.

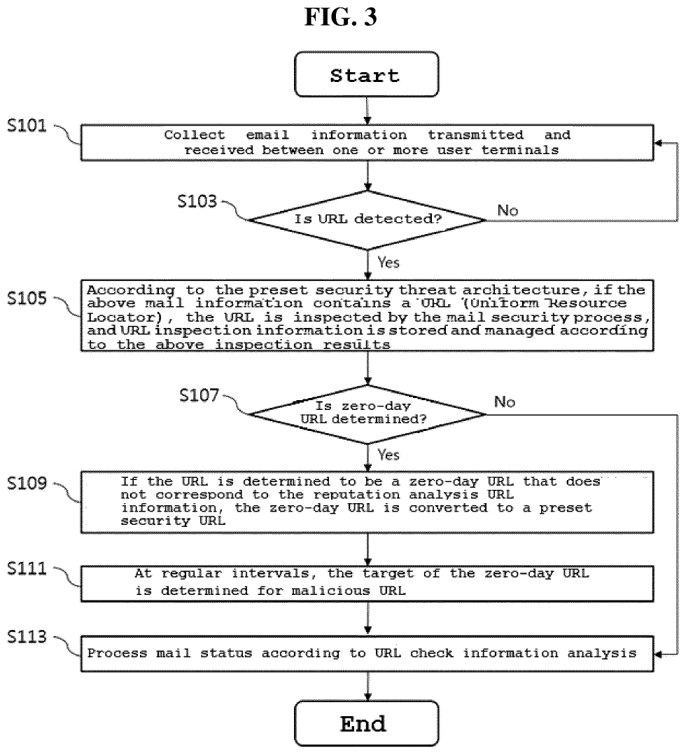

FIG. 3 is a flowchart for explaining a method of operating a device for providing a protective service against a mail security-based zero-day attack according to an embodiment of the present invention.

Referring to FIG. 3, in the method of operating a device for providing a protective service against a zero-day attack, a collection step (S101) may collect email information transmitted and received between one or more user terminals 200.

In addition, it is determined whether URLs are collected in the mail information (S103).

A security threat inspection step (S105) may inspect, when the mail information includes a Uniform Resource Locator (URL), the URL by the mail security process. The security threat inspection step (S105) may store and manage URL inspection information according to a result of the inspection.

In the mail security process, a different mail security process corresponding to an incoming mail or an outgoing mail may be determined according to the security threat architecture. In addition, the inspection order or inspection level of the mail security process may be determined by a preset security level and architecture.

In addition, it is determined whether a zero-day URL is determined in the inspection result (S107).

When the URL is determined as a zero-day URL that does not correspond to the reputation analysis URL information on the basis of the URL inspection information, the URL conversion step (S109) may convert the zero-day URL into a preset secure URL.

A zero-day URL diagnosis step (S111) may diagnose whether or not the zero-day URL is a malicious URL at regular intervals.

The zero-day URL diagnosis step (S111) may further include a URL tracking step (not shown) of acquiring URL chain information by tracking and managing one or more first derived URLs connected from the zero-day URL and [n-th] derived URLs successively derived through the first derived URLs at regular intervals.

In addition, the zero-day URL diagnosis step (S111) may further include a URL chain diagnosis step (not shown) of diagnosing whether the [n-th] derived URL is a malicious URL at regular intervals on the basis of the URL chain information, and storing and managing the chain diagnosis information.

A mail processing step (S113) may process the mail state according to analysis of the URL inspection information. The mail processing step (S113) may further include a zero-day mail processing step (not shown) of replacing the zero-day URL with the secure URL and processing the mail including the zero-day URL into a receiving state that allows the user terminal 200 to access.

Aa s URL classification information management step (not shown) is further included, information determined as one among a normal URL, a malicious URL, and a zero-day URL may be stored and managed as URL classification information according to analysis of the URL inspection information.

As a secure URL connection step (not shown) is further included, when the user terminal 200 receiving a mail including the secure URL requests connection to the secure URL, the request is primarily redirected from the user terminal 200 to a security device designated as a secure URL, and the secure URL connection step may process connection to the zero-day URL and the [n-th] derived URL determined not to be a malicious URL on the basis of the diagnosis information.

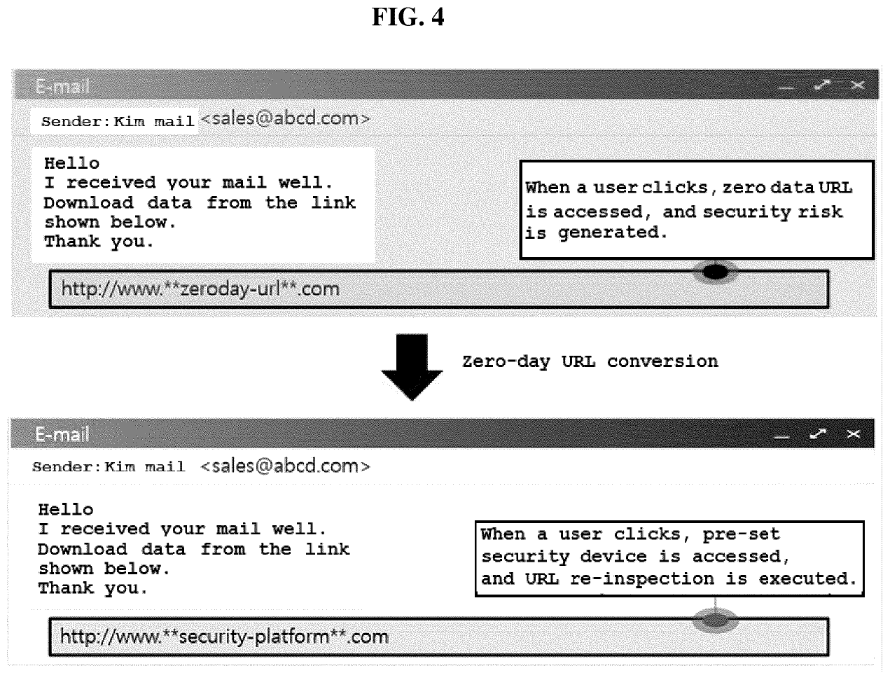

FIG. 4 is an exemplary view for explaining an incoming mail applied with URL conversion through a device for providing a protective service against a mail security-based zero-day attack according to an embodiment of the present invention.

Referring to FIG. 4, mails transmitted from the outside may be collected through a mail server. At this point, the service providing device 100 may confirm a URL detected through execution of a mail security process as http://www.**zeroday-url**.com. The service providing device 100 may determine whether the URL is a zero-day URL by inspecting the URL. When the URL is determined as a zero-day URL through the inspection, the service providing device 100 may convert http://www.**zeroday-url**.com into a secure URL. The secure URL is converted into http://www.**security-platform**.com set in advance and applied to the contents of the mail, and the mail may be transmitted to the recipient.

Through this, the recipient may confirm the mail contents sent by Kimmail and the URL information included in the mail contents as http://www.**security-platform**.com, which is a secure URL. When the zero-day URL is clicked through the user terminal 200, it may be connected to a web page or the like that cannot be guaranteed as a normal URL, and security risk may occur through this.

Contrarily, when the converted secure URL is clicked through the user terminal 200, it may be connected to a web page or the like provided by a security device guaranteed as a secure URL. Thereafter, the security device performs a security inspection on http://www.**zeroday-url**.com, which is a real URL, in real time, and when it is determined that it is safe, access to the real URL is allowed, and the user terminal 200 may be connected.

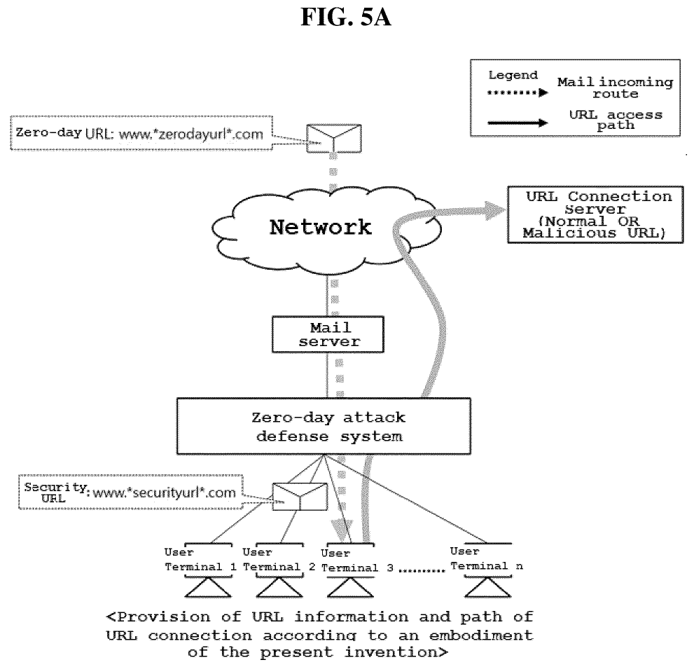

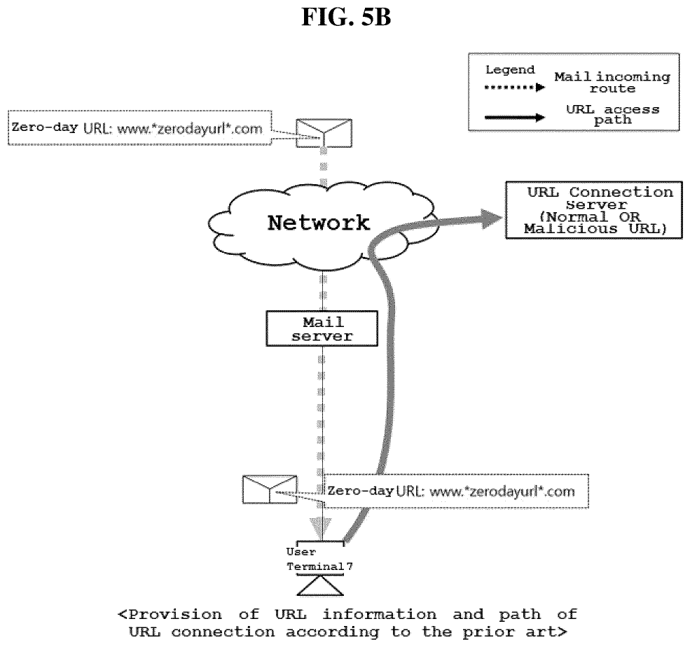

FIGS. 5A and 5B are exemplary views for explaining comparison of URL access paths according to incoming routes of mail through a device for providing a protective service against a mail security-based zero-day attack according to an embodiment of the present invention.

Referring to FIG. 5A, it is an exemplary view for explaining provision of URL information and a path of URL connection according to an embodiment of the present invention. An outsider may send a mail containing zero-day URL ‘www.*zerodayurl*.com’. User terminal 3 may read the mail received through the mail server and the zero-day attack defense system. At this point, ‘www.*zerodayurl*.com’ is converted into ‘www.*securityurl*.com’ and provided to user terminal 3. User terminal 3 may request connection by clicking the included URL to additionally confirm mail contents. At this point, ‘www.*securityurl*.com’, which is the URL clicked by user terminal 3, is called, and user terminal 3 is connected to the zero-day attack defense system to which the IP address is mapped. The zero-day attack defense system may provide information such as access status or the like to user terminal 3 through a web page or the like. The information such as connection status is a message indicating that although the original URL included in the mail contents delivered to user terminal 3 is ‘www.*zerodayurl*.com’, as it is determined as a zero-day URL, a message or the like indicating that inspection is conducted to prevent security risk may help understanding.

At the same time, the zero-day attack defense system may inspect whether the ‘www.*zerodayurl*.com’ is a malicious URL. When the zero-day attack defense system determines that the ‘www.*zerodayurl*.com’ is a malicious URL, it may block the link to the URL and block access of user terminal 3. Contrarily, when the zero-day attack defense system determines that the ‘www.*zerodayurl*.com’ is a normal URL without a security threat, it may allow the link to the URL and connect user terminal 3 to ‘www.*zerodayurl*.com’.

Referring to FIG. 5B, it is an exemplary view for explaining provision of URL information and a path of URL connection according to the prior art. An outsider may send a mail containing zero-day URL ‘www.*zerodayurl*.com’. User terminal 7 receives the mail without performing a security inspection on ‘www.*zerodayurl*.com’, which is a zero-day URL sent from the outsider, or taking an action of changing the URL. Since user terminal 7 does not go through the zero-day attack defense system, a security inspection of determining whether the www.*zerodayurl*.com information is a malicious URL or a normal URL is not performed. Through this, when connection to the URL is requested, user terminal 7 may be exposed not to be protected from attacks such as stealing of personal information, download of malicious codes, execution of malicious scripts, and the like when the URL is malicious.

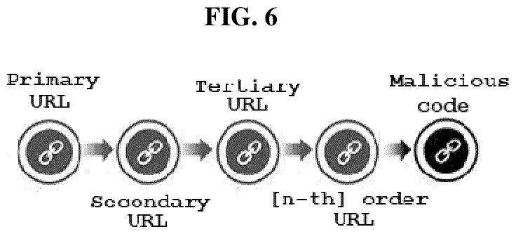

FIG. 6 is an exemplary view for explaining an inspection method according to an architecture of a mail security service according to an embodiment of the present invention.

Referring to FIG. 6, when the primary URL determined to be a zero-day URL provides a service as a web page, the zero-day URL may form a menu on the web page, and through this, an additional operation of the web page may be executed. Through this, the zero-day URL may provide an additional link to move to a secondary URL. The secondary URL may provide a tertiary URL through an additional link, and it may be confirmed that tertiary, quaternary, and [n-th] order URLs are subsequently derived therefrom. Whether or not a malicious URL is detected may be determined by performing security inspection on the URL at each step, and whether a malicious code is found may be determined by tracking up to the end point.

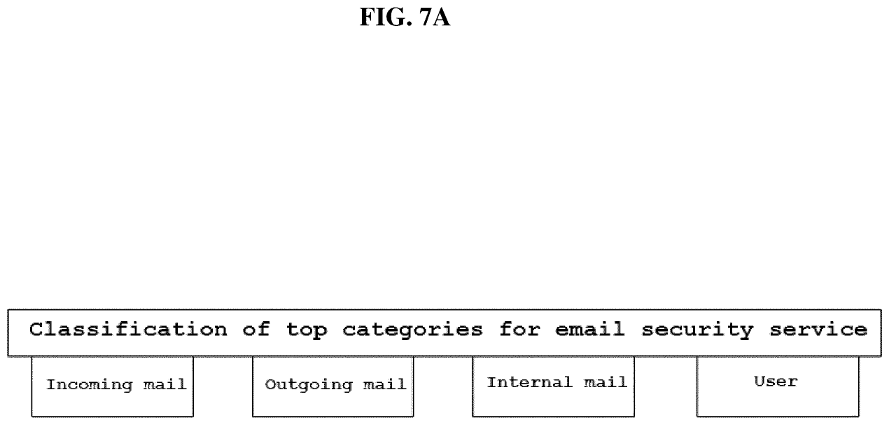

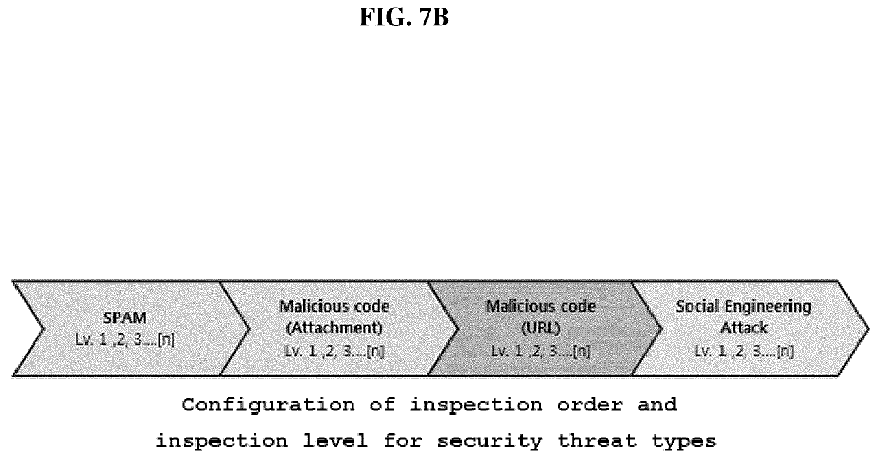

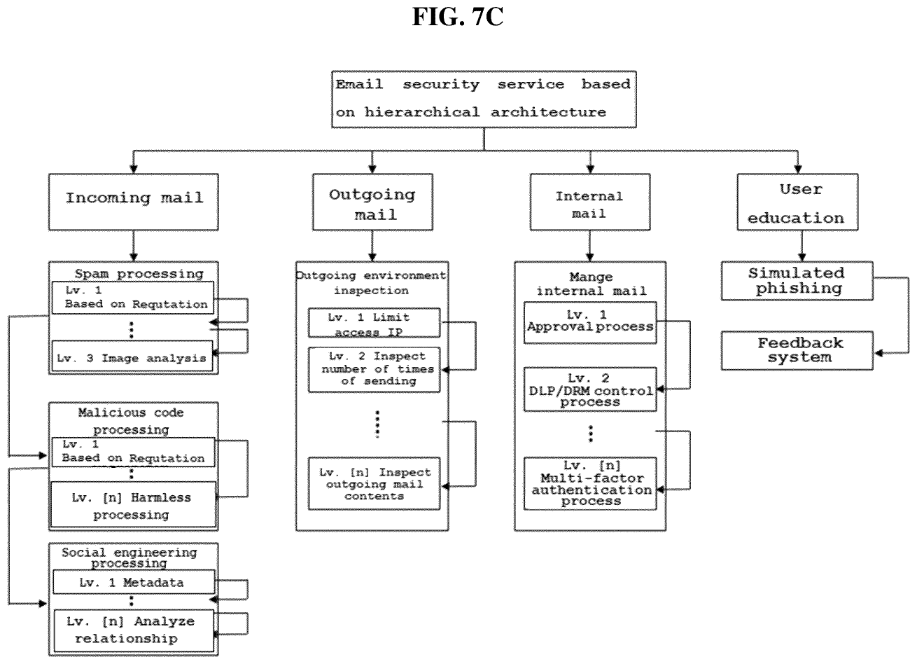

FIGS. 7A, 7B, and 7C are exemplary views for explaining an inspection method according to a mail security architecture according to an embodiment of the present invention.

Referring to FIGS. 7A, 7B, and 7C, it is an architecture for providing mail security, and accordingly, the type and level, process, priority, processing order, and the like of security threats may be set. The architecture of the mail security service is divided into top categories such as incoming mail, outgoing mail, internal mail, user education, and the like, and hierarchical and step-by-step configurations and processing methods may be applied to each category as a substructure. The top categories may be classified based on the attribute values included in the mail information or the classification of systems to be accessed according to the purpose of using the mail by the user terminal 200.

One or more specific mail security processes may be assigned within each security threat type, and the mail security processes may be divided into levels and sequentially executed step by step. Specifically, the security threat types may be classified into spam, malicious code (attachment), malicious code (URL), social engineering attack, and the like. A process of inspecting the security threat type according thereto may be sequentially performed. In addition, the inspection processes may be divided into steps of level 1, 2, 3, . . . [n] in each security threat type to be performed sequentially. At this point, an inspection result may be acquired as specific inspection items and indexes are assigned to each level.

In addition, according to setting of the architecture, the mail security process in each security threat type may also be performed in a way of processing allocated inspection areas in parallel.

The security threat type of the incoming mail, which is one of the top categories, may be divided into sublayers. Specifically, the security threat type may be classified into spam processing, malicious code processing, social engineering processing, and the like.

In order to inspect the security threat of an incoming mail, whether or not the incoming mail is a spam mail may be inspected on the basis of reputation at level 1 (Lv. 1) in the spam processing section. Thereafter, when no problem is found in the spam mail inspection based on reputation, whether or not the incoming mail is a spam mail may be inspected at level 2 (Lv. 2) through filtering on the basis of user-designated keywords.

After the inspection of level 2 is completed, whether or not the incoming mail is a spam mail may be inspected at level 3 (Lv. 3), which is a next step, through analysis of contents based on image. In this way, the mail security service architecture may perform inspection at each level through a specific spam filtering process within the spam processing type, and proceeds to a next level when the inspection is completed. In addition, the mail security service architecture may proceed to a malicious code processing step of determining whether or not a malicious code is included in the mail after the spam inspection of the mail through spam processing is completed.

The malicious code processing may determine whether or not a malicious code of level 1 based on reputation is included, and proceed to a next step when the mail is confirmed to be normal. When it is determined at level n (Lv. n) that an attached file may include a malicious code, the malicious code processing step may be terminated through a harmless process that modifies the execution code included in the attached file. When the malicious code processing inspection is completed, the inspection step may proceed to a social engineering processing inspection step. At the social engineering process inspection step, a response may be processed or requested according to inspection result information after executing a social engineering attack mail inspection process based on metadata of level 1 (Lv. 1) and relationship analysis of level n (Lv. n).

The security threat type of the outgoing mail, which is one of the top categories, may be divided into sublayers. The inspection may be performed by classifying the category of the outgoing mail into steps of spam processing, malicious code processing, and social engineering processing, like the security threat type of the incoming mail.

Particularly, security threat inspection of outgoing mail may include an outgoing environment inspection step. When one or more user terminals 200 access the system for the purpose of sending mail, the outgoing environment inspection step may perform a step of level 1 (Lv. 1) of verifying whether the user terminal has an IP address allowed according to a previously registered whitelist. When the user terminal 200 authenticated through the inspection of level 1 satisfies the number of times of sending mail in less than a predetermined reference number of times, it can be determined as a normal mail and proceeds to the next step. Thereafter, whether or not the mail is normal may be verified at the step of level n (Lv. n) by inspecting the contents of the outgoing mail in advance and executing a process of determining whether or not the mail is abnormal.

An internal mail management step capable of preventing leakage of internal information to a sublayer may be performed on the internal mail, which is one of the top categories. At the internal mail management step, abnormal mail may be inspected through an approval process of level 1 (Lv. 1). The approval process may determine the risk of information leakage of a mail including internal information.

The approval process may be performed in a way of pre-censoring mail contents approved sequentially by the mail management system and sent to the outside. Then, as a step of level 2 (Lv. 2), control processes of Data Loss Prevention (DLP) and Digital Rights Management (DRM) may be performed to inspect leakage of internal information. The DLP control process may detect and control a behavior of attempting to transmit information by accessing a system violating a policy without permission such as approval or the like. The DRM control process may detect and control an attempt of decrypting an encrypted internal document or attaching a decrypted file to a mail without permission such as approval or the like. Thereafter, the step of level n (Lv. n) may provide a multi-step authentication process such as step 1, step 2, and the like as a step of authenticating the user terminal 200 when a mail is to be sent. Through this, processing of normal mail can be guaranteed by blocking users who attempt snatching or stealing of account.

The user education, which is one of the top categories, may include the steps of simulated phishing and a feedback system as sublayers. At the simulated phishing step, information such as the identification value of the user terminal 200 having a history of using mail containing security threats and the number of times of using the mail may be stored and managed. A mail configured in a way actually harmless to the system or contents may be used as the security threat. Through this, the feedback system may provide statistical values calculated through the simulated phishing or result values obtained by analyzing threat levels.

The security threat inspection configured for each category may be determined by the architecture and security levels. Accordingly, the inspection order and inspection level can be determined, and abnormalities can be confirmed according to sequential inspections. In addition, the priority of the inspection order and inspection level may be set according to the architecture and security levels. When a problem is found according to the obtained inspection result, the process performed according to the priority may perform a process needed at that step and determine whether or not to terminate the inspection. The above problem can be solved by discarding or returning the mail so that the user terminal 200 may not confirm the mail when the mail is determined as a spam mail or a mail containing malicious codes. When the problems of a mail are processed through an inspection process at a specific step in this way, subsequent inspection steps may be terminated without being performed.

The methods according to the present invention described above may be manufactured as a program to be executed on a computer and stored in a computer-readable recording medium, and examples of the computer-readable recording medium include ROM, RAM, CD-ROM, magnetic tapes, floppy disks, optical data storage devices and the like, and also includes those implemented in the form of a carrier wave (e.g., transmission over the Internet).

The computer-readable recording medium may be distributed in computer systems connected through a network, so that computer-readable codes may be stored and executed in a distributed manner. In addition, functional programs, codes, and code segments for implementing the method may be easily inferred by the programmers in the art to which the present invention belongs.

In addition, although preferred embodiments of the present invention have been illustrated and described above, the present invention is not limited to the specific embodiments described above, and various modified embodiments can be made by those skilled in the art without departing from the gist of the invention claimed in the claims, and in addition, these modified embodiments should not be individually understood from the spirit or perspective of the present invention.

1. A service providing device comprising:
a collection unit for collecting information on mail transmitted and received between one or more user terminals;
a security threat inspection unit for inspecting, when a URL is included in the email information, the URL by a mail security process according to a preset security threat architecture, and storing and managing URL inspection information according to a result of the inspection;
a zero-day URL conversion unit for converting, when the URL is determined as a zero-day URL having a potential zero-day attack risk, the zero-day URL into a preset secure URL on the basis of the URL inspection information; and
a zero-day URL diagnosis unit for periodically diagnosing whether the zero-day URL is a malicious URL.

2. The device according to claim 1, further comprising a mail processing unit for processing a mail state according to analysis of the URL inspection information, wherein the mail processing unit includes a zero-day mail processing unit for replacing the zero-day URL with the secure URL, and processing the mail including the zero-day URL into a receiving state that allows the user terminal to access.

3. The device according to claim 2, further comprising a URL classification information management unit for storing and managing information determined as one among a normal URL, a malicious URL, and a zero-day URL as URL classification information according to analysis of the URL inspection information.

4. The device according to claim 3, wherein the zero-day URL diagnosis unit includes a URL tracking module for acquiring URL chain information by tracking and managing one or more first derived URLs connected from the zero-day URL and [n-th] derived URLs successively derived through the first derived URLs at regular intervals.

5. The device according to claim 4, wherein the zero-day URL diagnosis unit further includes a URL chain diagnosis module for diagnosing whether the [n-th] derived URL is a malicious URL at regular intervals on the basis of the URL chain information, and storing and managing chain diagnosis information.

6. The device according to claim 5, further comprising a secure URL connection unit for primarily redirecting, when the user terminal receiving a mail including the secure URL requests connection to the secure URL, the request from the user terminal, and processing connection to the zero-day URL and the [n-th] derived URL determined not to be a malicious URL on the basis of the diagnosis information.

7. The device according to claim 1, wherein the malicious URL includes one or more among induction of personal information input, download of malicious codes, execution of malicious scripts, and attack on web vulnerability.

8. A method of operating a service providing device, the method comprising:
a collection step of collecting information on mail transmitted and received between one or more user terminals;
a security threat inspection step of inspecting, when a URL is included in the email information, the URL by a mail security process according to a preset security threat architecture, and storing and managing URL inspection information according to a result of the inspection;
a zero-day URL conversion step of converting, when the URL is determined as a zero-day URL having a potential zero-day attack risk, the zero-day URL into a preset secure URL on the basis of the URL inspection information; and
a zero-day URL diagnosis step of periodically diagnosing whether the zero-day URL is a malicious URL.

9. The method according to claim 8, further comprising a mail processing step of processing a mail state according to analysis of the URL inspection information, wherein the main processing step further includes a zero-day mail processing step of replacing the zero-day URL with the secure URL, and processing the mail including the zero-day URL into a receiving state that allows the user terminal to access.

10. The method according to claim 9, further comprising a URL classification information management step of storing and managing information determined as one among a normal URL, a malicious URL, and a zero-day URL as URL classification information according to analysis of the URL inspection information.

11. The method according to claim 10, wherein the zero-day URL diagnosis step further includes a URL tracking step of acquiring URL chain information by tracking and managing one or more first derived URLs connected from the zero-day URL and [n-th] derived URLs successively derived through the first derived URLs at regular intervals.

12. The method according to claim 11, wherein the zero-day URL diagnosis step further includes a URL chain diagnosis step of diagnosing whether the [n-th] derived URL is a malicious URL at regular intervals on the basis of the URL chain information, and storing and managing chain diagnosis information.

13. The method according to claim 12, further comprising a secure URL connection step of primarily redirecting, when the user terminal receiving a mail including the secure URL requests connection to the secure URL, the request from the user terminal, and processing connection to the zero-day URL and the [n-th] derived URL determined not to be a malicious URL on the basis of the diagnosis information.

14. The method according to claim 8, wherein the malicious URL includes one or more among induction of personal information input, download of malicious codes, execution of malicious scripts, and attack on web vulnerability.
